(19) United States
(12) Patent Application Publication
(10) Pub. No.: US 2023/0214672 A1
(43) Pub. Date: Jul. 6, 2023

(54) DEVICE AND METHOD FOR GENERATING NETWORK USING COMPLEX NETWORK PROPERTIES

(71) Applicant: ELECTRONICS AND TELECOMMUNICATIONS RESEARCH INSTITUTE, Daejeon (KR)

(72) Inventor: Byounghwa LEE, Daejeon (KR)

(21) Appl. No.: 17/936,254

(22) Filed: Sep. 28, 2022

(30) Foreign Application Priority Data
Jan. 5, 2022 (KR) 10-2022-0001721

(51) Int. Cl. G06N 5/02; G06K 9/62; G06N 7/00

(52) U.S. Cl. CPC G06N 5/022; G06K 9/6215; G06N 7/005

(57) ABSTRACT

Provided are a device and method for generating a network using complex network properties. According to the present invention, by introducing knowledge of a complex network and generating a plurality of substitutable degenerated networks as an ensemble to statistically process noise and missing links, it is possible to generate graph instances and data from which intrinsic defects of original data are removed. A device for generating a network according to the present invention includes an original network construction unit configured to construct an original network for data received from the outside, a complex network parameter extraction unit configured to construct a parameter set with complex network parameters extracted from the original network, and a degenerated network generation unit configured to generate a degenerated network that satisfies the parameter set within a predetermined error range.

### CROSS-REFERENCE TO RELATED APPLICATION

This application claims priority to and the benefit of Korean Patent Application No. 10-2022-0001721, filed on Jan. 5, 2022, the disclosure of which is incorporated herein by reference in its entirety.

### BACKGROUND

### 1. Field of the Invention

The present invention relates to a device and method for receiving data that can be represented by a network and generating a plurality of alternative networks having substantially the same network parameters and different microscopic structures based on the data.

### 2. Discussion of Related Art

Self-supervised learning (SSL) is a type of unsupervised learning, and is performed in a way that maximizes the similarity of representations between instances of the same data in the absence of a label that is the correct answer. SSL has made notable achievements in the field of computer vision such as image classification. After two images that are the same as the original but slightly different are created by rotation, color distortion, cropping, etc., the representation may be obtained through an encoder and the similarity between two values (positive pair) from a decoder may be maximized, so it is possible to update the encoder and learn the diversity of the same image. This process is called a pretext task, and transferring an encoder trained through the pretext task or performing various tasks suitable for purposes such as image classification through fine tuning is called a downstream task. A case in which data is not an image but a graph or a network composed of nodes and links is called graph SSL and corresponds to a data input value in the present invention. All tabular data can be represented in a graph by calculating the relationship between variables or features.

A disadvantage of conventional graph SSL is that, unlike the field of computer vision, the development of a technique for augmenting data instances is slow. In the case of computer vision SSL, there are numerous augmentation techniques such as rotation, color distortion, and cropping. However, the existing augmentation techniques for graph SSL include techniques such as simple node/link dropout, feature masking, subgraph sampling, and graph diffusion. These techniques have a problem in that they are indirect and do not sufficiently consider context.

Meanwhile, as limitations of the existing graph-based model and SSL, two major limitations may be mentioned.

(1) There is a noisy link in the actual data. For example, in a recommendation system, users accidentally click on products (items) by mistake, but a connection between the users and the products is recorded in data. Such noise is present in real service and business data, and good models should differentiate these noise links and should not reflect them in learning. However, the current graph-based model and SSL do not have a method of differentiating these noise links.

(2) There may be missing links or unobserved links. This refers to a connection that should or may actually be present, but a link that is not present in data. The link may simply have been omitted in a data collection and recording operation, but it is also possible that there are unobserved connections because these connections are not actually manifested. For example, there is no record of users watching specific content in the content recommendation system, so there is no link between the users, but since there is a lot of content, the users may not know that the corresponding content is still there. However, when the users know that there is the corresponding content, it may be inferred that the users will watch content with a high probability based on a users' past viewing history and preference profile. It is difficult for the current graph-based model and SSL to perform the pretext task including such missing or unobserved links. In addition, it is difficult to find the missing links based on tasks such as randomly adding links.

### SUMMARY OF THE INVENTION

The present invention is directed to providing a device and method for generating a network capable of generating a substitutable network that has substantially the same complex network parameters but is slightly different only in a detailed adjacency matrix by introducing an augmentation technique theoretically based on the context of a network structural aspect.

The present invention is directed to providing a network self-supervised learning device and method for performing self-supervised learning using a set of a plurality of degenerated networks satisfying complex network parameters and alternative networks extracted therefrom as augmented graph instances in order to solve a noise link and alternate link problems from a statistical point of view.

According to an aspect of the present invention, a device for generating a network includes: an original network construction unit configured to construct an original network for data received from an outside; a complex network parameter extraction unit configured to construct a parameter set with complex network parameters extracted from the original network; and a degenerated network generation unit configured to generate a degenerated network that satisfies the parameter set within a predetermined error range.

The device for generating a network may further include: an alternative network selection unit configured to calculate a score for similarity between the original network and the degenerated network and select an alternative network for the original network from the degenerated network based on the score.

The source network construction unit may construct the original network in such a way that a network between variables is configured based on at least any one of similarity between the variables constituting the data and an amount of mutual information.

The complex network parameter extraction unit may construct the parameter set with non-contradictory parameters among the complex network parameters extracted from the original network.

The complex network parameter extraction unit may extract, from the original network, a complex network parameter including at least any one of the number of nodes, the number of links, a degree, a degree distribution, assortativity, a degree correlation, a clustering coefficient, an average shortest path length, centrality, a community structure, motif, a network significance profile (SP), global efficiency, local efficiency, and a spectral property of graph Laplacian.

The degenerated network generation unit may generate the degenerated network that satisfies the parameter set within a predetermined error range but has a different phenotype from the original network.

The degenerated network generation unit may generate the degenerated network through at least any one of a perturbation method and a link exchange method according to a Monte-Carlo process based on the original network, and the perturbation method may perform at least any one of node addition, node deletion, link addition, and link deletion.

The degenerated network generation unit may generate the degenerated network using at least any one of a Barabasi-Albert model, an Erdos-Renyi model, a Watts-Strogatz model, a copying model, an edge inheritance model, a Bianconi-Barabasi model, a fitness model, an aging model, a Dorogovshev-Mendez-Samukin model, an initial attractive model, a nonlinear preferential attachment model, and an accelerated growth model.

The alternative network selection unit may calculate the score using at least any one of Shannon entropy, a spectral method, cosine similarity, an inner product, and a Euclidean distance.

The alternative network selection unit may select the alternative network according to any one of a method of selecting a predetermined number of alternative networks from the degenerated network in an order of a highest score and a method of selecting a degenerated network having a score greater than or equal to a predetermined threshold as an alternative network.

According to another aspect of the present invention, a network self-supervised learning device includes: a network generation module configured to construct an original network for data received from the outside, generate an alternative network identical to at least one parameter extracted from the original network, and generate a network set composed of the original network and the alternative network; and a self-supervised learning module configured to train a network encoder using a network sampled from the network set. The encoder may receive a network and may transform the received network into a representation in a latent space.

The self-supervised learning module may include: a sampling unit configured to sample network pairs from the network set; an encoding unit configured to input the network pairs to the encoder to generate a representation of the network pairs; a pretext decoding unit configured to generate a projection for the representation; and a loss calculation unit configured to calculate a mutual information amount between the network pairs based on the projection, and calculate a loss of similarity between the network pairs based on the mutual information amount. In this case, the encoding unit may train the encoder based on the loss.

The loss calculation unit may calculate the loss using at least any one of Kullback-Leibler divergence and an information noise-contrastive estimator (InfoNCE).

According to still another aspect of the present invention, a method of generating a network includes: an operation of constructing an original network for data received from an outside; a complex network parameter extraction operation of constructing a parameter set with complex network parameters extracted from the original network; and an operation of generating a degenerated network satisfying the parameter set within a predetermined error range.

The method of generating a network may further include: a degenerated network score calculation operation of calculating a score for similarity between the original network and the degenerated network; and an operation of selecting an alternative network for the original network from the degenerated networks based on the score.

In the operation of constructing the original network, the original network may be constructed in such a way that a network between variables is configured based on at least any one of similarity between the variables constituting the data and an amount of mutual information.

In the complex network parameter extraction operation, the parameter set may be composed of non-contradictory parameters among the complex network parameters extracted from the original network.

In the operation of generating the degenerated network, the degenerated network that satisfies the parameter set within a predetermined error range but has a different phenotype from the original network may be generated.

In the operation of generating the degenerated network, the degenerated network may be generated through at least any one of a perturbation method and a link exchange method according to a Monte-Carlo process based on the original network, and the perturbation method may perform at least any one of node addition, node deletion, link addition, and link deletion.

In the operation of selecting the alternative network, the score may be calculated using at least any one of Shannon entropy, a spectral method, cosine similarity, an inner product, and a Euclidean distance.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a device for generating a network according to an embodiment of the present invention;

FIG. 2 is a reference diagram illustrating information transferred between components of the device for generating a network according to the embodiment of the present invention;

FIG. 3 is a flowchart for describing a method of generating a network according to the embodiment of the present invention;

FIG. 4 is a block diagram illustrating a configuration of a network self-supervised learning device according to an embodiment of the present invention; and

FIG. 5 is a flowchart for describing a network self-supervised learning method according to an embodiment of the present invention.

FIG. 6 is a block diagram illustrating a computer system for implementing the method according to the embodiment of the present invention.

### DETAILED DESCRIPTION OF EXEMPLARY EMBODIMENTS

Various advantages and features of the present invention and methods accomplishing them will become apparent from the following description of embodiments with reference to the accompanying drawings. However, the present invention is not limited to the embodiments disclosed herein, but will be implemented in various forms. The embodiments allow the disclosure of the present invention to be thorough and are provided so that those skilled in the art can easily understand the scope of the present invention. Therefore, the present invention will be defined by the scope of the appended claims. Meanwhile, terms used in the present specification are for explaining the embodiments rather than limiting the present invention. Unless otherwise stated, a singular form includes a plural form in the present specification. “comprise” and/or “comprising” used in the present invention indicate(s) the presence of stated components, steps, operations, and/or elements but do(es) not exclude the presence or addition of one or more other components, steps, operations, and/or elements.

When it is decided that the detailed description of the known art related to the present invention may obscure the gist of the present invention, the detailed description thereof will be omitted.

A “node” used herein has the same meaning as a vertex, and a “link” has the same meaning as an edge or an arc. The terms “graph” and “network”′ are used interchangeably. However, the “graph” emphasizes a mathematical meaning, and the “network” emphasizes a complex network aspect.

The present invention relates to a device and method for generating a plurality of alternative networks that have similar parameter values to the original network, but have a different microscopic structure by receiving data that can be represented by a network and using a network parameter set with complex network properties. In addition, the present invention presents a graph self-supervised learning (SSL) augmentation technique using an alternative network as an input value of SSL.

The present invention relates to a network having similar parameter values by introducing a set of parameters of a complex network as a constraint, but actual realization of the network is configured as an augmented alternative network by selecting degenerated networks composed of different adjacency matrices. The parameters of the complex network are macroscopic observables, and even though the parameters have similar parameter values, a microscopic structure may be different. In this case, the microscopic structure is represented by the adjacency matrix or the connectivity equivalent thereto. A plurality of networks that have complex network parameter values within a predetermined error range from an original network but have different microscopic structures may be present, and a set of such networks is referred to as a degenerated network in the present invention. An alternative network is obtained by selecting a degenerated network having a score similar to that of the original network obtained from data in the order of highest score, and is used as an augmented instance of SSL, in which the score uses Shannon entropy or an information metric equivalent thereto.

The complex network is a network that has a large network size and a network in which connections between nodes show a clear difference from a random graph. The complex network has characteristics of (1) a power-law degree distribution, (2) an average shortest path length proportional to a logarithm of the network size, or small world, and (3) a clustering coefficient that is significantly larger than that of the random graph. Large amounts of data, such as protein interaction, biological networks such as a food web, technical networks such as the Internet (WWW), social networks, recommendation systems, knowledge graphs, and citation networks, may be represented by complex networks.

The parameters of the complex network used in the present invention are composed of a combination of the following properties or properties equivalent thereto. The parameters includes the number of nodes, the number of links, a degree, a degree distribution, assortativity, a degree correlation, a clustering coefficient, an average shortest path length, centrality including betweenness centrality, eigenvector centrality, closeness centrality, Katz centrality, and the like, a community structure, motif, a network significance profile (SP), global efficiency, local efficiency, transitivity, and a spectral property of the graph Laplacian, and the like. In this case, the parameter set should be selected so that there is no contradiction that may not be represented in an actual network.

Hereinafter, embodiments of the present invention will be described in detail with reference to the accompanying drawings. The same means will be denoted by the same reference numerals throughout the accompanying drawings in order to facilitate the general understanding of the present invention in describing the present invention.

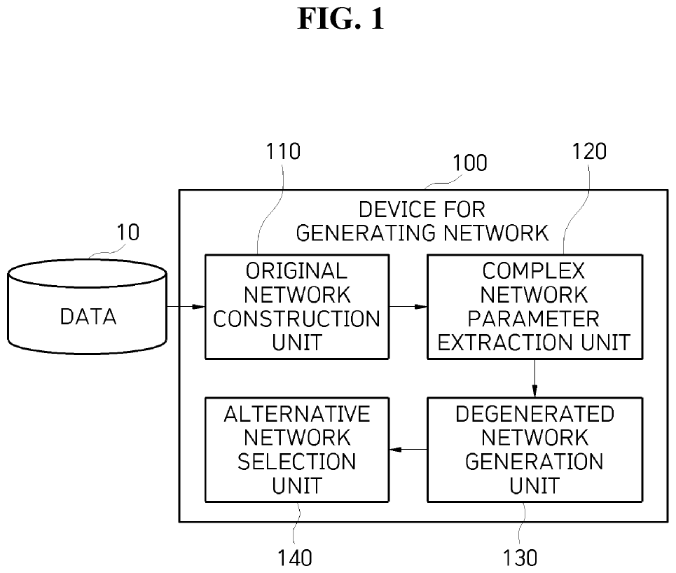

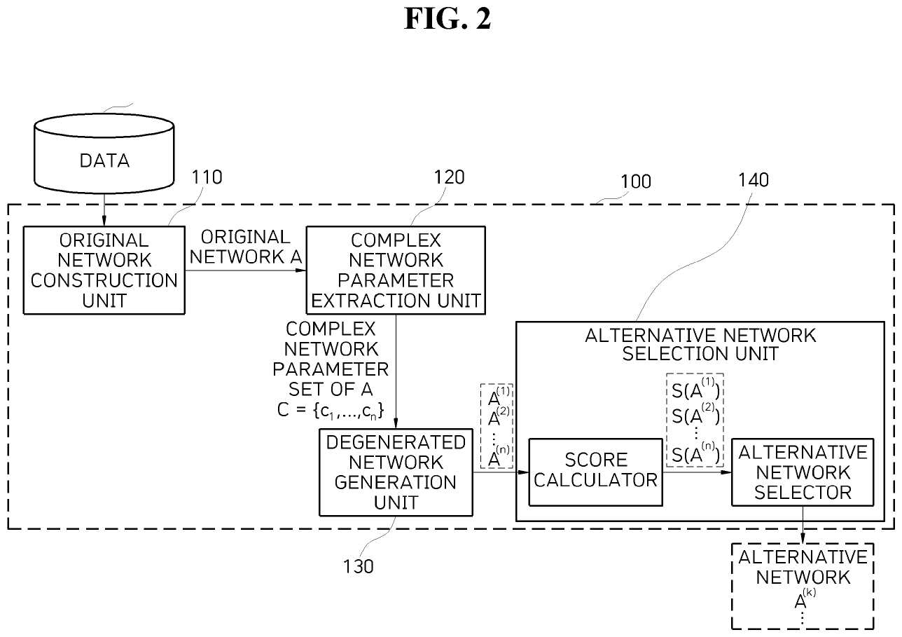

FIG. 1 is a block diagram illustrating a configuration of a device for generating a network according to an embodiment of the present invention, and FIG. 2 is a reference diagram illustrating information transferred between components of the device for generating a network according to the embodiment of the present invention.

A device 100 for generating a network according to the embodiment of the present invention is a device for generating an alternative network that may construct an original network by receiving data that can be represented by a graph (or network), and then may substitute for the original network according to an alternative network generation algorithm. The device 100 for generating a network includes an original network construction unit 110, a complex network parameter extraction unit 120, a degenerated network generation unit 130, and an alternative network selection unit 140.

The original network construction unit 110 constructs an original network from data 10. The data 10 used in the present invention can be any data that can be represented by a graph and a network.

Examples of data 10 usable in the present invention may include medical data such as an electronic medical record (EMR) and an electronic health record (EHR) as tabular data that can be represented in a table, data such as personal information and activities obtained by sensors, social data and social network data obtained through social media, messages, calls, etc., recommendation data obtained from a recommendation system, a protein-protein interaction network, a food web network, a gene regulatory network, a metabolic network, a biological network such as a gut microbiome network, a technical network such as the World Wide Web (WWW), a semantic network such as papers, patents, and knowledge encyclopedias such as Wikipedia, a co-author network, a citation network, and a knowledge graph composed of knowledge and meaning contained in these networks as a network, a keyword network constructed through keywords appearing in various literatures, documents, laws, papers, and patents, the Internet of Things (IoT) network composed of data obtained from sensors attached to home appliances, devices, and factory machinery and their connections, an origin-destination (OD) network related to movement of people, and an infrastructure network such as a road network, a public transportation network, and a power grid, and the like. In addition to the above examples, any data that may be composed of nodes and links may be used as data for the present invention.

The method of an original network construction unit 110 to construct an original network from data 10 is as follows. (1) In the case of data composed of nodes and links so that data itself may be represented by a network, the original network construction unit 110 may construct the data itself as an original network. In addition, (2) the original network construction unit 110 may construct a network between variables by calculating similarity such as correlation between features or variables of data, a metric in a similar manner thereto, a metric based on mutual information (MI) or an information theory, and the like.

The complex network parameter extraction unit 120 extracts complex network parameter values from the original network, and constructs a parameter set with complex network parameters (values). The complex network parameter extraction unit 120 extracts, from the original network, complex network parameter values of at least any one of the number of nodes, the number of links, a degree, a degree distribution, assortativity, a degree correlation, a clustering coefficient, an average shortest path length, centrality including betweenness centrality, eigenvector centrality, closeness centrality, Katz centrality, and the like, a community structure, motif, a network SP, global efficiency, local efficiency, transitivity, and a spectral property of the graph Laplacian, and the like. The complex network parameter extraction unit 120 selects n parameters, which are non-contradictory, from the complex network parameters, and constructs a complex network parameter set C={c₁, . . . , cₙ}.

The degenerated network generation unit 130 generates a degenerated network that satisfies a complex network parameter set within a predetermined error range. There are various ways in which the degenerated network generation unit 130 obtains a degenerated network that satisfies the complex network parameter set C.

When the size n of the complex network parameter set is large, the degenerated network generation unit 130 may find several networks satisfying the parameter conditions while continuously exchanging links through a Monte-Carlo process or a similar process thereto. Also, the degenerated network generation unit 130 may generate the degenerated network even through a perturbation method in which nodes/links are added or deleted.

When the complex network parameter set is simple, the degenerated network generation unit 130 may generate (1) various degenerated networks that satisfy constraints using a Barabasi-Albert model among the complex network generation models only when the number of nodes, the number of links, the degree distribution, the clustering coefficient, and the average shortest path length are included as the constraints, and may generate (2) various degenerated networks that satisfy constraints using an Erdos-Renyi model when the complex network parameters of the original network are similar to the complex network parameters of the random network, and the number of nodes, the number of links, and the degree distribution are included as the constraints.

The degenerated network generation unit 130 may generate the degenerated network using a Barabasi-Albert model, an Erdos-Renyi model, a Watts-Strogatz model, a copying model, an edge inheritance model, a fitness model such as a Bianconi-Barabasi model, an aging model, an initial attractive model such as a Dorogovshev-Mendez-Samukin model, a nonlinear preferential attachment model, an accelerated growth model, and the like, in addition to the Monte-Carlo process, the perturbation method, a Barabasi-Albert model, and an Erdos-Renyi model.

Depending on the shape of the original network and the composition of the complex network parameter set, the usable network generation model may vary. However, when the degenerated network generation unit 130 follows the above-described Monte-Carlo process or a process similar thereto, the degenerated network generation unit 130 may generate several degenerated networks by diversifying the microscopic structure and the adjacency matrix as its phenotype while satisfying the user desired parameter set through link exchange.

The Monte-Carlo process may be summarized in four steps as follows.

\textcircled{1} Operation of setting a domain of possible input values

\textcircled{2} An operation of randomly generating an input value within a domain based on a given probability distribution (in the case of link exchange, randomly selecting a link based on the given probability distribution)

\textcircled{3} An operation of performing deterministic computation on an input value (in the case of link exchange, two randomly selected links are exchanged)

\textcircled{4} An operation of repeating the previous process and aggregating the results

Here, when the degenerated network generation unit 130 performs the link exchange, the degenerated network generation unit 130 repeats the processes of \textcircled{2} and \textcircled{3} until the constraint of the complex network parameter set is satisfied within a predetermined number of times to obtain the final degenerated network.

The degenerated network generation unit 130 may generate a plurality of degenerated networks by repeating the Monte-Carlo process several times. Although all of the degenerated networks have complex network parameters within a predetermined error range from the original network (that is, the macroscopic structure is similar), the microscopic structure, which is the detailed connectivity of each node, and the adjacency matrix, which is its phenotype, are both different. Therefore, all of the degenerated networks generated by the degenerated network generation unit 130 may substitute for the original network, but may be candidate networks having a slightly different detailed structure.

The alternative network selection unit 140 calculates the scores of each degenerated network, and selects an alternative network that can substitute for the original network based on the scores of each degenerated network. The degenerated network generated by the degenerated network generation unit 130 may be used as the alternative network of the original network. However, when it is necessary to select the most appropriate network among the degenerated networks, the alternative network selection unit 140 selects the alternative network based on the score of the degenerated network.

A criterion for the alternative network selection unit 140 to select the most appropriate alternative network is represented by a score function. The score function is a function that may measure a microscopic structural difference between two networks, and the measuring method is not limited.

The alternative network selection unit 140 may measure the difference in microscopic structure from the original network by measuring the Shannon entropy between the original network and the degenerated network. The Shannon entropy is given as [Equation 1].

$$H ( X ) = - {\sum }_{i = 1}^{N} P ( {x}_{i} ) log P ( {x}_{i} ) \qquad [ Equation 1 ]$$

In [Equation 1], X is a random variable, and xi denotes a value that X may have.

There may be various methods for an alternative network selection unit 140 to calculate Shannon entropy on a network, and two examples will be described below.

(1) The Shannon entropy of the degree distribution may be obtained. The Shannon entropy of the degree distribution may be obtained as in [Equation 2].

$$H ( k ) = - {\sum }_{κ = 1}^{N} P ( k ) log P ( k ) \qquad [ Equation 2 ]$$

In [Equation 2], k denotes a degree.

Also, (2) the entropy may be obtained by locating a random walker on the network.

In addition, the alternative network selection unit 140 may measure the similarity between two networks using a spectral method. A Laplacian matrix is given by L=D−A, D denotes a degree matrix, A denotes an adjacency matrix, and a spectrum of the network is determined by an eigenvalue of the Laplace matrix. The alternative network selection unit 140 may measure the similarity by comparing spectra of two networks.

In addition, the alternative network selection unit 140 may calculate the scores of each degenerated network using any one of a cosine similarity, an inner product, and a Euclidean distance of two parameter vectors.

The alternative network selection unit 140 constructs a score function through any one of the methods of measuring a difference in network microstructure including the above-described method, and calculates the scores for each degenerated network based on the score function.

The alternative network selection unit 140 selects the alternative network based on the score. The alternative network selection unit 140 selects only one degenerated network having the highest score based on the score calculated through the score function (Top-1), or selects K degenerated networks having the highest score (Top-K). In addition, the alternative network selection unit 140 may select the Top-K alternative network in a way that, through an appropriate threshold which is a kind of hyperparameter set in advance based on the scores of each degenerated network, when a score is less than the threshold, the score is excluded, and when a score is greater than the threshold, the score is selected.

The alternative network thus obtained may be used as an input value with a different view from the original in SSL, an input value for generating missing values for data imputation, or an input value for generating data of a minority class in oversampling for resolving class imbalance.

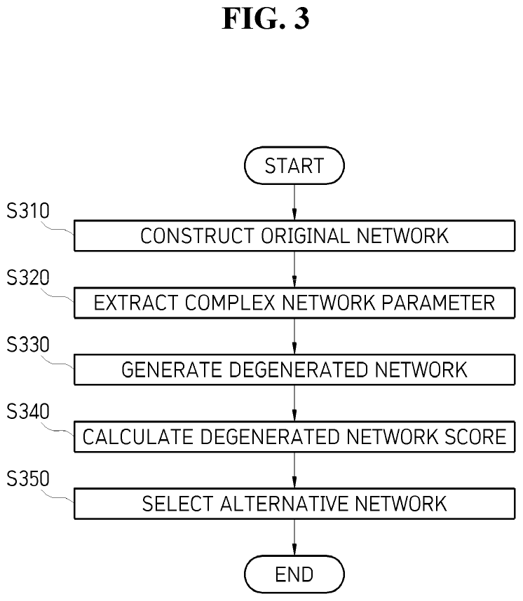

FIG. 3 is a flowchart for describing a method of generating a network according to the embodiment of the present invention. The method of generating a network according to the embodiment of the present invention includes operations S310 to S330, and may further include operations S340 and S350.

Operation S310 is an operation of constructing an original network. This operation is an operation of constructing an original network from data. The original network construction unit 110 constructs the original network from the data 10. The data 10 used in the present invention can be any data that can be represented by a graph and a network. The method for an original network construction unit 110 to construct an original network from data 10 is (1) a method of constructing data composed of a node and a link as an original network, and (2) a method of constructing a network between features or variables of data based on similarity between the features or variables, MI, and the like. Details have been described above in the description of the original network construction unit 110.

Operation S320 is an operation of extracting a complex network parameter. This operation is an operation of extracting complex network parameters from the original network constructed in operation S310, and constructing a complex network parameter set with the extracted parameters. The complex network parameter extraction unit 120 extracts the complex network parameter set from the original network. The complex network parameter extraction unit 120 extracts, from the original network, a complex network parameter including at least any one of the number of nodes, the number of links, a degree, a degree distribution, assortativity, a degree correlation, a clustering coefficient, an average shortest path length, centrality, a community structure, motif, network SP, global efficiency, local efficiency, and a spectral property of the graph Laplacian. The complex network parameter extraction unit 120 selects non-contradictory parameters from the complex network parameters, and constructs the complex network parameter set for the original network. Details have been described above in the description of the complex network parameter extraction unit 120.

Operation S330 is an operation of generating a degenerated network. This operation is an operation of generating the degenerated networks that satisfy the complex network parameter set extracted in operation S320. The degenerated network generation unit 130 generates the degenerated network that satisfies the complex network parameter set. As the method for a degenerated network generation unit 130 to obtain a degenerated network satisfying a complex network parameter set C, there are the Monte-Carlo process, the perturbation method, the Barabasi-Albert model, the Erdos-Renyi model, and the like. In addition, the degenerated network generation unit 130 may generate the degenerated network using models such as the Watts-Strogatz model, the copying model, the edge inheritance model, the fitness model such as the Bianconi-Barabasi model, the aging model, the initial attractive model such as the Dorogovshev-Mendez-Samukin model, the nonlinear preferential attachment model, the accelerated growth model, and the like.

The degenerated network generation unit 130 may generate a plurality of degenerated networks using at least one of the above methods. Although all of the degenerated networks have complex network parameters within a predetermined error range from the original network (that is, the macroscopic structure is similar), the microscopic structure, which is the detailed connectivity of each node, and the adjacency matrix, which is its phenotype, are both different. Therefore, all of the degenerated networks generated by the degenerated network generation unit 130 may substitute for the original network, but may be candidate networks having a slightly different detailed structure. Details have been described above in the description of the degenerated network generation unit 130.

The degenerated network generated in operation S330 may be used as an alternative network to the original network. However, when it is necessary to select an appropriate network from the degenerated networks, the scores of each degenerated network are calculated in operation S340, and the alternative network is selected in operation S350 based on the score calculated in operation S340.

Operation S340 is an operation of calculating a degenerated network score. This operation is an operation of calculating a score for the similarity between the original network and the degenerated network. The criterion for selecting an appropriate alternative network is represented by a score function. The score function is a function that may measure a microscopic structural difference between two networks, and the measuring method is not limited. The alternative network selection unit 140 may measure the difference in microscopic structure from the original network by measuring the Shannon entropy between the original network and the degenerated network, or measure the similarity between two networks using the spectral method. The alternative network selection unit 140 may construct the score function through any one of the methods of measuring a difference in network microstructure including the Shannon entropy measurement and the spectral method, and calculate the scores for each degenerated network from the constructed score function. The alternative network selection unit 140 may calculate the scores of each degenerated network using any one of a cosine similarity, an inner product, and a Euclidean distance of two parameter vectors, in addition to the Shannon entropy or the spectral method. Details are described above in the description of the alternative network selection unit 140.

Operation S350 is an operation of selecting an alternative network. This operation is an operation of selecting an alternative network based on the score calculated in S340. The alternative network selection unit 140 selects the alternative network based on the score. The alternative network selection unit 140 selects only one degenerated network having the highest score based on the score calculated through the score function (Top-1), or selects K degenerated networks having the highest score (Top-K). Details are described above in the description of the alternative network selection unit 140.

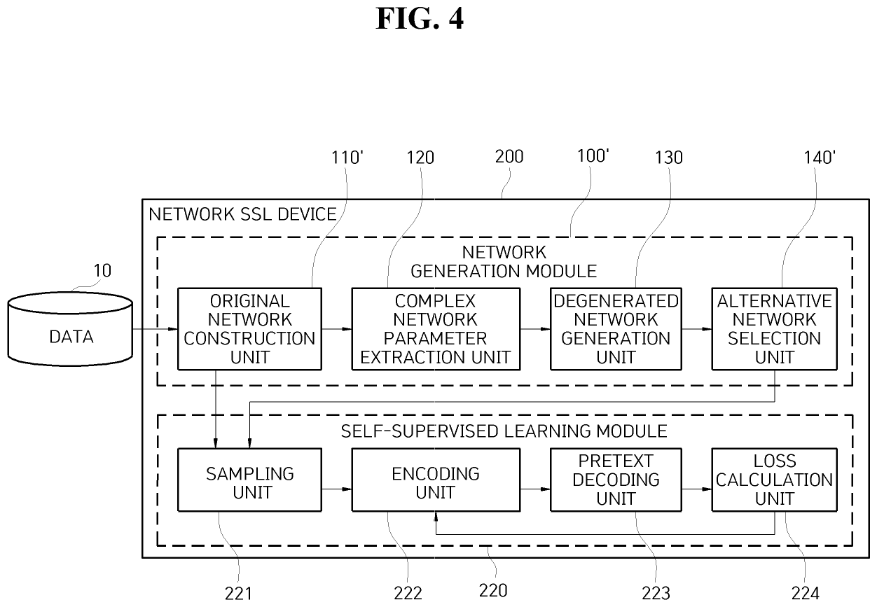

FIG. 4 is a block diagram illustrating a configuration of a network SSL device according to an embodiment of the present invention.

A network SSL device 200 according to the embodiment of the present invention includes a network generation module 100′ that generates an alternative network and an SSL module 220 that performs SSL with an alternative network.

The components and functions of the network generation module 100′ are the same as those of the device 100 for generating a network. However, in the network SSL device 200, each of the original network construction unit 110′ and the alternative network selection unit 140′ of the network generation module 100′ provide the set of the original network and the Top-K alternative network as the input of the SSL module 220. As another example, the alternative network selection unit 140′ may construct the network set composed of the original network and the Top-K alternative network and provide the constructed network set to the SSL module 220 as the input.

The SSL module 220 includes a sampling unit 221, an encoding unit 222, a pretext decoding unit 223, and a loss calculation unit 224.

The sampling unit 221 samples a network pair from a network set. The sampling unit 221 selects a network pair A^{(k)} and A^{(k′)} or a subgraph thereof required for SSL through sampling from a set composed of the Top-K alternative network and the original network A. When selecting two networks, for the purpose of SSL and in some cases, the sampling unit 221 may sample the original network A, and then sample the remaining one from the alternative network set. The number of times of sampling varies in some cases, and all sampling such as random sampling and sequential sampling are possible, and possible regardless of reconstruction extraction or non-reconstruction extraction. The sampling unit 221 transmits the sampled network pair or the subgraph thereof to the encoding unit 222.

The encoding unit 222 receives the sampled network pair or the subgraph thereof and inputs the received sampled network pair or subgraph to an encoder to obtain representation of each network. The encoder of the encoding unit 222 requires two inputs as a positive pair. This refers to two views of one and the same data (graph) instance, but from different perspectives, and in the present invention, two sampled network pairs A^{(k)} and A^{(k′)} or the subgraph thereof may be configured as positive pairs. The encoding unit 222 converts the original vector into a vector representation in a new latent space through the encoder.

The encoder used in the encoding unit 222 is mainly configured by stacking a graph neural network or a graph convolutional network with several propagation layers, and in this case, any deep neural network may also be the encoder.

The encoding unit 222 takes the positive pair as the input of the encoder, and embeds the two networks A^{(k)} and A^{(k′)} into an appropriate latent space through the encoder to generate the representation of the two networks A^{(k)} and A^{(k′)}. The two representations may be in the form of vectors, and contain implicit information of two networks or subgraphs thereof, or nodes and links.

The pretext decoding unit 223 receives the representation of the network generated by the encoding unit 222 to generate a projection. The pretext decoding unit 223 generates projections of two networks A^{(k)} and A^{(k′)} by inputting each representation into a pretext decoder. The pretext decoder serves to interpret a representation with implicit information and unravel the interpreted representation into an original space for a necessary task. The pretext decoding unit 223 generates the projections of the networks A^{(k)} and A^{(k′)} through the pretext decoder. The projection is a form for a downstream task, such as a classification task, and may be represented by a vector.

The loss calculation unit 224 calculates a loss based on an estimator calculation criterion according to the MI or the information theory equivalent thereto based on the two projections (projection vectors) received from the pretext decoding unit 223 and transmits the loss to the encoding unit 222.

The MI is defined as in [Equation 3]. Specifically, when two instance pairs (xi, xi) are given and the representation of the projection generated by the pretext decoding unit 223 is represented by (hᵢ, hⱼ), the MI of (i, j) is represented as in [Equation 3].

$$MI ( {h}_{i} , {h}_{j} ) = KL ( P ( {h}_{i} , {h}_{j} ) ‖ P ( {h}_{i} ) P ( {h}_{j} ) ) = {𝔼}_{P ( {h}_{i} , {h}_{j} )} [ log \frac{P ( {h}_{i} , {h}_{j} )}{P ( {h}_{i} ) P ( {h}_{j} )} ] \qquad [ Equation 3 ]$$

In [Equation 3], KL is the Kullback-Leibler divergence.

In addition, as a widely used estimator, there is an information noise-contrastive estimator (InfoNCE), which is given as in [Equation 4].

$$M {I}_{N C E} ( {h}_{i} , {h}_{j} ) = [ log \frac{+ {\sum }_{n ∈ N}}{} ] \qquad [ Equation 4 ]$$

In [Equation 4], [symbol] (⋅) is a discriminator, and a dot product or an inner product is possible. That is, in the case of the dot product or the inner product, [symbol] (hᵢ,hⱼ)=hᵢ^{T}hⱼ/τ, and T is temperature, a hyperparameter. [symbol] is a set of positive pairs, and [symbol] is a set of N negative pairs.

The loss calculation unit 224 transmits the calculated loss to the encoding unit 222. The loss may be obtained by adding a negative sign to the MI obtained through [Equation 3] or the InfoNCE obtained through [Equation 4], and additionally, supervised loss and regularization terms may further be included. The encoding unit 222 updates the encoder by performing backpropagation based on the loss. The loss calculated by the loss calculation unit 224 is a loss calculated by one-time execution, and the encoder of the encoding unit 222 may be trained by repeatedly calculating the loss a predetermined number of times and feeding the calculated loss back to the encoding unit 222. In this case, the meaning of learning is that values of each weight of the neural network constituting the encoder are adjusted in a negative gradient direction, which is a direction to reduce the loss. Through this, the encoding unit 222 trains the encoder in a direction in which the encoder weight maximizes the similarity between the original network and the alternative network.

It is possible to optimize the MI or the estimator corresponding thereto by repeating the above-described process. Here, the “optimization” includes “maximization” or “minimization.”

Meanwhile, learning may be performed on one alternative network (pair), or learning may be performed on a plurality of alternative networks (pairs). That is, the above-described learning process may be repeated by selecting a new sample from the alternative network set belonging to Top-K. Accordingly, the accuracy in which the encoder of the encoding unit 222 constructs a representation increases, and robustness to various networks may be obtained through the learning of slightly different alternative networks. Additionally, learning about a negative pair may be performed. The learning about the negative pair may be different in some cases. For reference, the negative pair is a pair of the original network and another network, and the learning about the negative pair is a process of learning to minimize the metric (estimator) based on the MI between the original network and another network or the information theory equivalent thereto while comparing the original network and another network. That is, the learning about the negative pair is learning to minimize the similarity between two networks from different sources, and it is possible to proceed with learning to maximize the similarity of the positive pair. The whole process is called a pretext task, and by repeating the pretext task by selecting a new sample, it is possible to finally obtain the encoder that may represent the given data well in the latent space as a result of learning.

Hereinafter, a method of applying a trained encoder to a downstream task desired by a user will be described. The trained encoder may be used to perform the downstream task. The downstream task is a process of obtaining a user-desired result. The downstream task may be largely divided into a node-level task including node classification, a link-level task including link prediction, a graph-level task including graph classification, and the like. The method of applying an encoder to a downstream task includes both of a method of using a weight of a pre-trained encoder as it is such as unsupervised representation learning and a method of fine-tuning a pre-trained encoder to new data such as pre-training and fine-tuning. In addition, a joint learning method of simultaneously learning a pretext task and a downstream task is also possible.

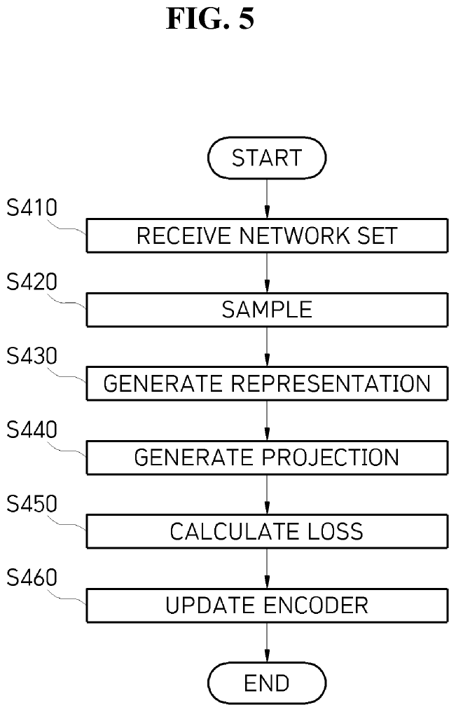

FIG. 5 is a flowchart for describing a network SSL method according to the embodiment of the present invention. The network SSL method according to the embodiment of the present invention includes operations S410 to S460. The network SSL method may be performed in conjunction with the above-described method of generating a network. That is, the original network and its alternative network generated through operations S310 to S330 or S310 to S350 may be received in operation S410. Therefore, there may be a network SSL method composed of all or some of operations S310 to S350 and S410 to S460.

Operation S410 is an operation of inputting a network set. This operation is an operation in which the SSL module 220 receives the network set from the network generation module 100′ for network SSL. The network generation module 100′ provides the network set composed of the original network and the Top-K alternative network to the SSL module 220.

Operation S420 is a sampling operation. This operation is an operation of sampling network pairs from a network set. The sampling unit 221 samples the network pair A^{-(k)} and A^{(k′)} or the subgraph thereof required for SSL through sampling from the network set. When selecting two networks, for the purpose of SSL and in some cases, the sampling unit 221 may sample the original network A, and then sample the remaining one from the alternative network set. The number of times of sampling varies according to the model, and all sampling such as random sampling and sequential sampling are possible, and possible regardless of reconstruction extraction or non-reconstruction extraction. Details have been described above in the description of the sampling unit 221.

Operation S430 is an operation of generating a representation. This operation is an operation of generating a representation of each network by inputting the network pair or subgraph to the encoder. The encoder of the encoding unit 222 requires two inputs (network pair or subgraph thereof) as a positive pair. The encoding unit 222 converts the original vector into a vector representation in a new latent space through the encoder. The representation may be in the form of a vector, and contain the implicit information of the network or the subgraph thereof, or the node and link. Details have been described above in the description of the encoding unit 222.

Operation S440 is an operation of generating a projection. This operation is an operation of generating projections for two networks based on the representation. The pretext decoding unit 223 generates a projection for the network by inputting the representation of the network to the pretext decoder. The projection is a form for the downstream task, such as a classification task, and may be represented by a vector. Details have been described above in the pretext decoding unit 223.

Operation S450 is an operation of calculating a loss. This operation is an operation of calculating a loss according to the estimator calculation standard according to the MI or the information theory equivalent thereto based on the two projections. The loss calculation unit 224 may calculate the MI through the above-described [Equation 3] or [Equation 4], and calculate the loss based on the calculated MI. Details have been described above in the description of the loss calculation unit 224.

Operation S460 is an operation of updating the encoder. This operation is an operation of training the encoder through backpropagation based on the loss. When the loss calculation unit 224 transmits the calculated loss to the encoding unit 222, the encoding unit 222 may train the encoder by performing the backpropagation based on the loss. In this case, the meaning of learning is that values of each weight of the neural network constituting the encoder are adjusted in the negative gradient direction, which is the direction to reduce the loss. Through this, the encoding unit 222 trains the encoder in the direction in which the encoder weight maximizes the similarity between the original network and the alternative network. Details have been described above in the description of the loss calculation unit 224.

In addition, the network SSL method described above may be performed based on the negative pair. In this case, in operation S410, the original network and another network are received, and in operation S450, when the MI between the two networks is large, the loss is calculated such that the loss increases (e.g., the MI may be regarded as a loss as it is), and in operation S460, according to the calculated loss, the encoder is trained so that the metric (estimator) based on the MI between the two networks or the information theory equivalent thereto is minimized.

Meanwhile, there may be cases where optimization is performed using a triplet loss in addition to the above-described MI and InfoNCE. In this case, the representation of the positive pair is trained to be close, and the representation of the negative pair is trained to be farther away.

In addition, the encoder may be trained by repeating the above-described operations S420 to S460 in order to secure the representation configuration accuracy of the encoder and robustness to various networks. That is, the encoder may be trained using a new sample selected from the network set (e.g., the network set composed of the original network and the Top-K alternative network) received in operation S410.

Meanwhile, in the description with reference to FIGS. 3 and 5, each operation may be further divided into additional operations or combined into fewer operations according to an implementation example of the present invention. Also, some operations may be omitted if necessary, and an order between the operations may be changed. In addition, even when other contents are omitted, the contents of FIGS. 1, 2, and 4 may be applied to the contents of FIGS. 3 and 5. In addition, the contents of FIGS. 3 and 5 may be applied to the contents of FIGS. 1, 2, and 4.

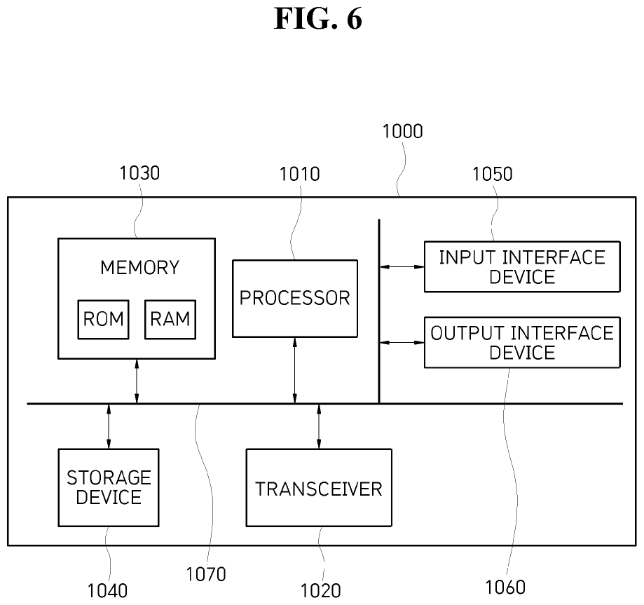

FIG. 6 is a block diagram illustrating a computer system for implementing the method according to the embodiment of the present invention.

Referring to FIG. 6, a computer system 1000 may include at least one of a processor 1010, a memory 1030, an input interface device 1050, an output interface device 1060, and a storage device 1040 which communicate via a bus 1070. The computer system 1000 may further include a transceiver 1020 coupled to a network. The processor 1010 may be a central processing unit (CPU) or a semiconductor device that executes instructions stored in the memory 1030 or the storage device 1040. The memory 1030 and the storage device 1040 may include various types of volatile or non-volatile storage media. For example, the memory may include a read only memory (ROM) and a random-access memory (RAM). In the embodiment of the present invention, the memory may be positioned inside or outside the processor, and the memory may be connected to the processor through various known units. The memory may include various types of volatile or non-volatile storage media. For example, the memory may include a ROM or a RAM.

Therefore, the embodiment of the present invention may be implemented as a method implemented in a computer or as a non-transitory computer-readable medium having computer-executable instructions stored therein. In an embodiment, when the computer-executable instructions are executed by the processor, the computer-executable instructions may perform the method according to at least one aspect of the present invention.

The transceiver 1020 may transmit or receive a wired signal or a wireless signal.

Further, the method according to the embodiment of the present invention may be implemented in the form of program instructions that can be executed through various computer units and recorded on computer readable media.

The computer readable media may include program instructions, data files, data structures, or combinations thereof. The program instructions recorded on the computer readable media may be specially designed and prepared for the embodiments of the invention or may be available well-known instructions for those skilled in the field of computer software. The computer readable media may include a hardware device configured to store and execute program instructions. Examples of the computer readable media include magnetic media such as a hard disk, a floppy disk, and a magnetic tape, optical media such as a compact disc read only memory (CD-ROM) and a digital video disc (DVD), magneto-optical media such as a floptical disk, and a hardware device, such as a ROM, a RAM, or a flash memory, that is specially made to store and perform the program instructions. Examples of the program instruction include machine code generated by a compiler and high-level language code that can be executed in a computer using an interpreter and the like.

While embodiments of the present invention have been described above in detail, the scope of the present invention is not limited thereto, but encompasses several modifications and improvements by those skilled in the art using basic concepts of embodiments of the present invention defined by the appended claims.

For reference, the components according to the embodiment of the present invention may be implemented in the form of software or hardware such as a digital signal processor (DSP), a field programmable gate array (FPGA), or an application specific integrated circuit (ASIC), and perform predetermined roles.

However, “components” are not limited to software or hardware, and each component may reside on an addressable storage medium or to reproduce one or more processors.

Accordingly, for example, the component includes components such as software components, object-oriented software components, class components, and task components, processors, functions, attributes, procedures, subroutines, segments of program code, drivers, firmware, microcode, circuits, data, databases, data structures, tables, arrays, and variables.

Components and functions provided within the components may be combined into a smaller number of components or further divided into additional components.

In this case, it will be appreciated that each block of a processing flowchart and combinations of the flowcharts may be executed by computer program instructions. Since these computer program instructions may be installed on a processor of a general computer, a special computer, or other programmable data processing apparatuses, these computer program instructions executed through the process of the computer or the other programmable data processing apparatuses create means performing functions described in a block(s) of the flow chart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including instruction means performing the functions described in the block(s) of the flowchart. Since the computer program instructions may also be installed on the computer or the other programmable data processing apparatuses, the instructions performing a series of operation steps on the computer or the other programmable data processing apparatuses to create processes executed by the computer, thereby it is also possible that executing the computer or the other programmable data processing apparatuses provide steps for performing the functions described in a block(s) of the flowchart.

In addition, each block may represent a module, a segment, or a portion of code including one or more executable instructions for executing a specific logical function (specific logical functions). Further, it is to be noted that functions mentioned in the blocks occur regardless of the order in some alternative embodiments. For example, two blocks that are continuously illustrated may in fact be simultaneously performed or performed in reverse order depending on corresponding functions.

In this case, the term “˜ unit” or “module” used in the present embodiment means software or hardware components such as an FPGA or ASIC, and “˜ unit” or “module” performs certain roles. However, the term “˜unit” or “module” is not meant to be limited to software or hardware. The “˜unit” or “module” may be stored in a storage medium that can be addressed or may be configured to regenerate one or more processors. Accordingly, as an example, the “˜unit” or “module” refers to components such as software components, object-oriented software components, class components, and task components, processes, functions, attributes, procedures, subroutines, segments of program code, drivers, firmware, microcode, circuits, data, databases, data structures, tables, arrays and variables. A plurality of components and functions provided within “˜unit” or “module” may be combined into a smaller number of components and “˜units” or “modules” or may be further separated into additional components and “˜units” or “modules.” In addition, components and “˜ units” and “modules” may be implemented to play one or more CPUs in a device or a secure multimedia card.

The above-described method of generating a network and network SSL method have been described with reference to the flowchart presented in the drawings. For simplicity, the method has been illustrated and described as a series of blocks, but the present invention is not limited to the order of the blocks, and some blocks may occur in a different order or concurrently with other blocks as illustrated and described in the present specification. Also, various other branches, flow paths, and orders of blocks that achieve the same or similar result may be implemented. In addition, not all the illustrated blocks may be required for implementation of the methods described in the present specification.

According to an embodiment of the present invention, by introducing complex network parameters, which are statistical properties, and presenting various degenerated networks as an ensemble, it is possible to remove noise from a statistical point of view. This is because a link that appears in common in a plurality of degenerated networks cannot be regarded as noise.

In addition, according to an embodiment of the present invention, by presenting a plurality of degenerated networks that satisfy complex network parameters as an ensemble, it is possible to present missing links from a statistical point of view. In other words, when there is no link in a network obtained from original data, but the link is present in the plurality of degenerated networks, there is an effect that the encoder can learn the representation including the link naturally through SSL.

Finally, by introducing knowledge of a complex network and generating a plurality of substitutable degenerated networks as an ensemble according to the present invention to statistically process noise and missing links, it is possible to generate graph instances and data from which intrinsic defects of original data are removed. By performing graph SSL through the graph instance from which intrinsic defects are removed, it is possible to improve the performance of the encoder representing the original network and perform various downstream tasks based on the improved performance of the encoder.

In addition, by using the data from which the intrinsic defects are removed according to the present invention, it is possible to solve a class imbalance problem and a missing value problem. In particular, the class imbalance problem has a disadvantage in that learning performance is deteriorated because a minority class instance is not sufficiently secured. According to the present invention, it is possible to solve a class imbalance problem by oversampling training data of a minority class by generating data through a network. In addition, since there are many missing values in an EHR, missing values are filled by various imputations.

In addition, even when a network generated according to the present invention is not used as an input for SSL, since the network can be used as training data for a machine learning model and a deep neural network model through several sets of network ensembles that are similar to but slightly different from the original network, the performance of the models can be improved through various training data.

Hereinabove, although the configuration of the present invention has been described in detail with reference to the accompanying drawings, this is merely an example, and those skilled in the art to which the present invention pertains can make various modifications and changes within the scope of the technical spirit of the present invention. Accordingly, it is to be understood that the scope of the present invention will be defined by the claims rather than the above-described description and all modifications and alternations derived from the claims and their equivalents are included in the scope of the present invention.

What is claimed is:

1. A device for generating a network, comprising:
an original network construction unit configured to construct an original network for data received from an outside;
a complex network parameter extraction unit configured to construct a parameter set with complex network parameters extracted from the original network; and
a degenerated network generation unit configured to generate a degenerated network that satisfies the parameter set within a predetermined error range.

2. The device of claim 1, further comprising an alternative network selection unit configured to calculate a score for similarity between the original network and the degenerated network and select an alternative network for the original network from the degenerated network based on the score.

3. The device of claim 1, wherein the source network construction unit constructs the original network in such a way that a network between variables is configured based on at least any one of similarity between the variables constituting the data and an amount of mutual information.

4. The device of claim 1, wherein the complex network parameter extraction unit constructs the parameter set with non-contradictory parameters among the complex network parameters extracted from the original network.

5. The device of claim 1, wherein the complex network parameter extraction unit extracts, from the original network, a complex network parameter including at least any one of the number of nodes, the number of links, a degree, a degree distribution, assortativity, a degree correlation, a clustering coefficient, an average shortest path length, centrality, a community structure, motif, a network significance profile (SP), global efficiency, local efficiency, and a spectral property of graph Laplacian.

6. The device of claim 1, wherein the degenerated network generation unit generates the degenerated network that satisfies the parameter set within a predetermined error range but has a different phenotype from the original network.

7. The device of claim 1, wherein the degenerated network generation unit generates the degenerated network through at least any one of a perturbation method and a link exchange method according to a Monte-Carlo process based on the original network, and
the perturbation method performs at least any one of node addition, node deletion, link addition, and link deletion.

8. The device of claim 1, wherein the degenerated network generation unit generates the degenerated network using at least any one of a Barabasi-Albert model, an Erdos-Renyi model, a Watts-Strogatz model, a copying model, an edge inheritance model, a Bianconi-Barabasi model, a fitness model, an aging model, a Dorogovshev-Mendez-Samukin model, an initial attractive model, a nonlinear preferential attachment model, and an accelerated growth model.

9. The device of claim 2, wherein the alternative network selection unit calculates the score using at least any one of Shannon entropy, a spectral method, cosine similarity, an inner product, and a Euclidean distance.

10. The device of claim 2, wherein the alternative network selection unit selects the alternative network according to any one of a method of selecting a predetermined number of alternative networks from the degenerated network in an order of a highest score and a method of selecting a degenerated network having a score greater than or equal to a predetermined threshold as an alternative network.

11. A network self-supervised learning device comprising:
a network generation module configured to construct an original network for data received from an outside, generate an alternative network in which at least one parameter is identical to a parameter extracted from the original network, and generate a network set composed of the original network and the alternative network; and
a self-supervised learning module configured to train a network encoder using a network sampled from the network set,
wherein the encoder receives a network and transforms the received network into a representation in a latent space.

12. The device of claim 11, wherein the self-supervised learning module includes:
a sampling unit configured to sample network pairs from the network set;
an encoding unit configured to input the network pairs to the encoder to generate a representation of the network pairs;
a pretext decoding unit configured to generate a projection for the representation; and
a loss calculation unit configured to calculate a mutual information amount between the network pairs based on the projection, and calculate a loss of similarity between the network pairs based on the mutual information amount,
wherein the encoding unit trains the encoder based on the loss.

13. The device of claim 12, wherein the loss calculation unit calculates the loss using at least any one of Kullback-Leibler divergence and an information noise-contrastive estimator (InfoNCE).

14. A method of generating a network, comprising:
an operation of constructing an original network for data received from an outside;
a complex network parameter extraction operation of constructing a parameter set with complex network parameters extracted from the original network; and
an operation of generating a degenerated network satisfying the parameter set within a predetermined error range.

15. The method of claim 14, further comprising:
a degenerated network score calculation operation of calculating a score for similarity between the original network and the degenerated network; and
an operation of selecting an alternative network for the original network from the degenerated networks based on the score.

16. The method of claim 14, wherein, in the operation of constructing the original network, the original network is constructed in such a way that a network between variables is configured based on at least any one of similarity between the variables constituting the data and an amount of mutual information.

17. The method of claim 14, wherein, in the complex network parameter extraction operation, the parameter set is composed of non-contradictory parameters among the complex network parameters extracted from the original network.

18. The method of claim 14, wherein, in the operation of generating the degenerated network, the degenerated network that satisfies the parameter set within a predetermined error range but has a different phenotype from the original network is generated.

19. The method of claim 14, wherein, in the operation of generating the degenerated network, the degenerated network is generated through at least any one of a perturbation method and a link exchange method according to a Monte-Carlo process based on the original network, and
the perturbation method performs at least any one of node addition, node deletion, link addition, and link deletion.

20. The method of claim 15, wherein, in the operation of selecting the alternative network, the score is calculated using at least any one of Shannon entropy, a spectral method, cosine similarity, an inner product, and a Euclidean distance.
